(19) United States
(12) Patent Application Publication
(10) Pub. No.: US 2026/0199775 A1
(43) Pub. Date: Jul. 16, 2026

(54) MANIPULATION SYSTEM FOR THE STIMULATION OF COGNITIVE ABILITIES

(71) Applicant: Geri-Gadgets, Ltd., Los Angeles, CA (US)

(72) Inventor: Angela L. Fairhurst, Los Angeles, CA (US)

(21) Appl. No.: 19/541,749

(22) Filed: Feb. 17, 2026

Related U.S. Application Data
(63) Continuation-in-part of application No. 18/668,111, filed on May 17, 2024, now Pat. No. 12,551,781.
Application No. 18/668,111 is a continuation of application No. 16/523,462, filed on Jul. 26, 2019, now Pat. No. 11,986,742.
(60) Provisional application No. 62/830,402, filed on Apr. 6, 2019.

(51) Int. Cl. A63F 9/06; A63F 13/79; A63H 33/00; A63H 33/04; G09B 1/00; G07F 17/32; G09B 1/02; G09B 1/32

(52) U.S. Cl. CPC A63F 9/0666; A63F 9/06; A63F 13/79; A63H 33/00; A63H 33/04; G09B 1/00; G07F 17/32; G09B 1/02; G09B 1/32

(57) ABSTRACT

An object manipulation system comprising a storage device and a plurality of objects, which are configured to be placed within the storage device and separately taken from the storage device. The object manipulation system helps stimulate cognitive abilities of a user and provide quality of life moments without the need for supervision by allowing the user to arrange the items according to one or more arranging cues. The object manipulation system also helps stimulate blood flow of the hands and arms of the user and provides the added stimulating benefits of exercise and flexibility by enabling the user to bend and manipulate one or more manipulative devices of the system. Particularly, in some embodiments, the plurality of objects are bendable and are able to be bent and manipulated as the objects are taken from the storage device and arranged according to the one or more arranging cues.

### RELATED APPLICATIONS

This Patent Application is a continuation-in-part of co-pending U.S. Patent Application Ser. No. 18/668,111, filed on May 17, 2024, titled “MANIPULATION SYSTEM FOR THE STIMULATION OF COGNITIVE ABILITIES” which is a continuation of co-pending U.S. Patent Application Ser. No. 16/523,462, filed on July 26, 2019, titled “MANIPULATION SYSTEM FOR THE STIMULATION OF COGNITIVE ABILITIES” which claims priority under 35 U.S.C. 119(e) of the co-pending U.S. provisional patent application, Application No. 62/830,402, filed on April 6, 2019, and entitled “MANIPULATION SYSTEM FOR THE STIMULATION OF COGNITIVE ABILITIES,” which are both also hereby incorporated by reference their entireties.

### FIELD OF THE INVENTION

The present invention relates generally to matching and manipulation toys, games and systems. More specifically, the present invention relates to a system for matching, manipulating and sorting a variety of items according to one or more arranging cues.

### BACKGROUND OF THE INVENTION

Currently one in nine Americans aged 65 and older has Alzheimer’s or another form of dementia. Dementia is a degenerative disorder that develops primarily in the nervous system and selectively damages areas of the brain. Typically, there are several stages of dementia, ranging from no impairment, to mild decline, to severe decline. Cognitive and social abilities may be slowly lost as the disease spreads throughout the brain. As dementia develops and persists, it is important for sufferers to maintain cognitive and physical stimulation.

### SUMMARY OF THE INVENTION

An object manipulation system comprising a storage device and a plurality of objects, which are configured to be placed within the storage device and separately taken from the storage device. The object manipulation system helps stimulate cognitive abilities of a user and provide quality of life moments without the need for supervision by allowing the user to arrange the items according to one or more arranging cues. The object manipulation system also helps stimulate blood flow of the hands and arms of the user and provides the added stimulating benefits of exercise and flexibility by enabling the user to bend and manipulate one or more manipulative devices of the system. Particularly, in some embodiments, the plurality of objects are bendable and are able to be bent and manipulated as the objects are taken from the storage device and arranged according to the one or more arranging cues.

In one aspect, a manipulation system comprises a storage device and a plurality of objects configured to be placed within the storage device and separately taken out of the storage device, wherein the plurality of objects are arrangeable according to one or more arranging cues. In some embodiments, the plurality of objects comprise a plurality of synthetic flowers and a vase, wherein the flowers are arrangeable within the vase and according to one or more patterns. In some embodiments, the plurality of objects comprise one or more of a basketball, a baseball, a soccer ball, an airplane, a boat, and a car. In further embodiments, the plurality of objects comprise a plurality of interlocking pieces configured to fit within a bottom of the storage device. In some of these embodiments, the plurality of interlocking pieces comprise a plurality of different shapes. In some embodiments, the plurality of objects comprise one or more of a round object, a jointed chain-like object, an object comprising one or more elastic tubes, and a puzzle. In some embodiments, the storage device comprises a bucket. In some of these embodiments, the plurality of objects comprise one or more of silicone, plastic and rubber.

In another aspect, a manipulation system for the stimulation of cognitive abilities comprises one or more arrangeable objects, the one or more arrangeable objects comprising one or more of a different sized object, a different shaped object, and a different textured object, wherein the one or more arrangeable objects are arrangeable according to one or more of size, shape and texture, one or more manipulative objects, the one or more manipulative objects comprising one or more of a bendable object and a stackable object and a storage bucket for removably holding the one or more arrangeable objects and the one or more manipulative objects when not being used. In some embodiments, the one or more arrangeable objects comprise one or more of a basketball, a baseball, a soccer ball, an airplane, a boat, a car, an animal and a tool. In further embodiments, the one or more arrangeable objects comprise a plurality of interlocking pieces. In some of these embodiments, the plurality of interlocking pieces comprise one or more tactile features. In some of these embodiments, the plurality of interlocking pieces comprise a plurality of different shapes. In further embodiments, the one or more arrangeable objects comprise one or more of a round object, an egg shaped object, a taco shaped object, a jointed chain-like object, an object comprising one or more elastic tubes and a puzzle. In some embodiments, the one or more manipulative objects comprise one or more of an object comprising one or more elastic tube, a segmented puzzle, a bendable ball, a bendable frisbee shaped object and a jointed chain-like object. In further embodiments, the one or more manipulative objects comprise a plurality of stackable items.

In a further aspect, a method of manufacturing a system for the stimulation of cognitive abilities comprises manufacturing one or more arrangeable objects, wherein the one or more arrangeable objects are arrangeable according to one or more of size, shape and texture, manufacturing one or more manipulative objects, manufacturing a storage bucket and placing the one or more arrangeable objects and the one or more manipulative objects in a bucket, wherein the storage bucket removably holds the one or more arrangeable objects and the one or more manipulative objects when they are not being used. In some embodiments, the one or more arrangeable objects comprise one or more of a different sized object, a different shaped object, and a different textured object. In some embodiments, the one or more manipulative objects comprise one or more of an elastic tube, a segmented puzzle, a bendable ball, a bendable frisbee shaped object and a jointed chain-like object. In further embodiments, the one or more manipulative objects comprise a plurality of stackable items.

### BRIEF DESCRIPTION OF THE DRAWINGS

FIGS. 1A-1F illustrate a storage device for a plurality of object in accordance with some embodiments.

FIGS. 2A and 2B illustrate a plurality of objects configured to fit within a storage device in accordance with some embodiments.

FIG. 3 illustrates a plurality of objects configured to fit within a storage device in accordance with some embodiments.

FIGS. 4A- 4E illustrate a plurality of objects configured to fit within a storage device in accordance with some embodiments.

FIGS. 5A-5F illustrate a plurality of objects configured to fit within a storage device in accordance with some embodiments.

FIG. 6 illustrates a plurality of objects configured to fit within a storage device in accordance with some embodiments.

FIG. 7 illustrates a plurality of objects configured to fit within a storage device in accordance with some embodiments.

FIG. 8 illustrates a plurality of objects configured to fit within a storage device in accordance with some embodiments.

FIG. 9 illustrates a method of manufacturing a system for the stimulation of cognitive abilities in accordance with some embodiments.

FIG. 10 illustrates a plurality of tools configured to fit within a storage device in accordance with some embodiments.

FIG. 11 illustrates music-related items configured to fit within a storage device in accordance with some embodiments.

FIG. 12 illustrates space-related items configured to fit within a storage device in accordance with some embodiments.

FIG. 13 illustrates dinosaur items configured to fit within a storage device in accordance with some embodiments.

FIG. 14 illustrates photograph-based items configured to fit within a storage device in accordance with some embodiments.

FIG. 15 illustrates a sorting container in accordance with some embodiments.

FIG. 16 illustrates an ice cream implementation according to some embodiments.

FIG. 17 illustrates nesting dolls according to some embodiments.

FIG. 18 illustrates tea set items according to some embodiments.

### DETAILED DESCRIPTION

Embodiments of the invention are directed to an object manipulation system comprising a storage device and a plurality of objects, which are configured to be placed within the storage device and separately taken from the storage device. The object manipulation system helps stimulate cognitive abilities of a user and provide quality of life moments without the need for supervision by allowing the user to arrange the items according to one or more arranging cues. The object manipulation system also helps stimulate blood flow of the hands and arms of the user and provides the added stimulating benefits of exercise and flexibility by enabling the user to bend and manipulate one or more manipulative devices of the system. Particularly, in some embodiments, the plurality of objects are bendable and are able to be bent and manipulated as the objects are taken from the storage device and arranged according to the one or more arranging cues. In some embodiments, one or more of the objects are jointed chain-like objects which make a clicking noise when bending.

Reference will now be made in detail to implementations of a manipulation system for the stimulation of cognitive abilities as illustrated in the accompanying drawings. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

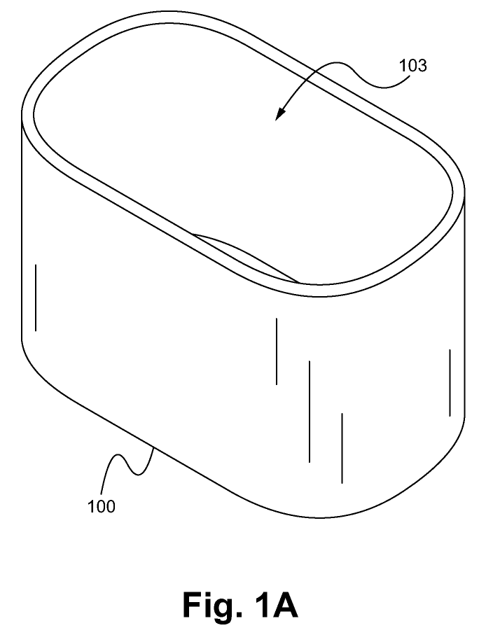

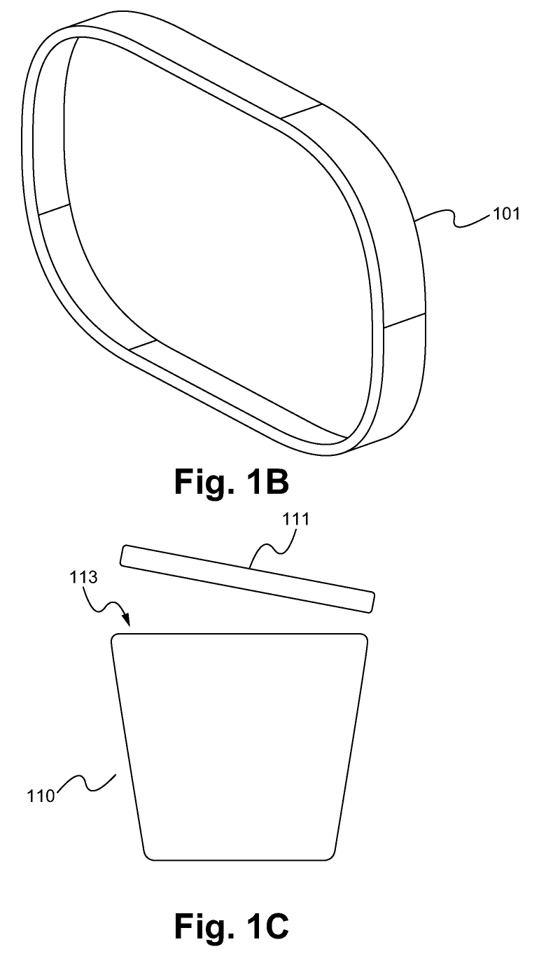

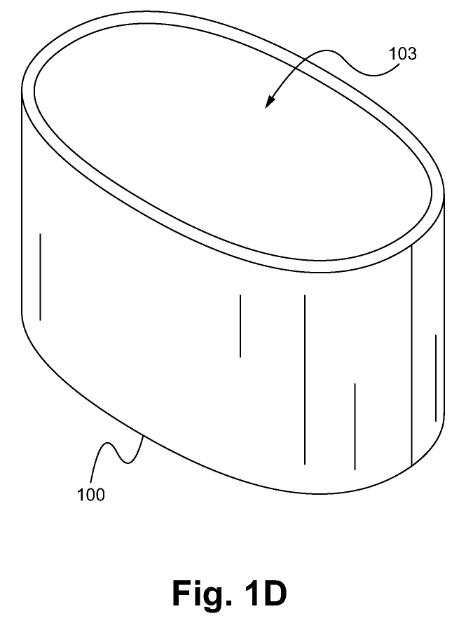

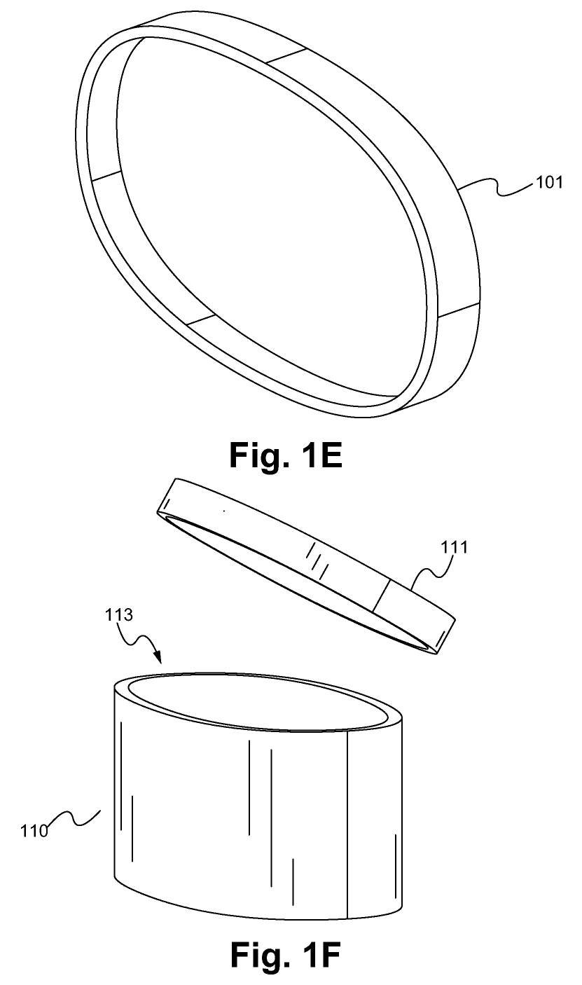

Referring now to FIGS. 1A-1C, a storage device 100 for storing a plurality of objects is depicted therein. In some embodiments, the storage device 100 comprises a silicone material. However, the storage device 100 is able to be constructed from any appropriately desired material. As shown within FIG. 1B, in some embodiments, the storage device 100 comprises a lid 101 which is opened to access an interior 103 of the storage device 100. In some embodiments, the storage device 100 comprises a plurality of pieces. In some embodiments, the storage device 100 comprises a handle.

The storage device 100 is able to be filled with a plurality of objects, such as flowers, shapes, sports themed objects, and other objects. The plurality of objects are configured to be placed within the storage device 100 and separately taken from the storage device 100. Particularly, in some embodiments, the storage device 100 comprises one or more shapes, or textures which correspond to the plurality of objects and enable a user to sort and/or arrange the objects according to the shapes and textures within the storage device 100.

As shown within FIG. 1C, the storage device such as described above comprises a silicone bucket 110. In some embodiments, such as shown within FIG. 1C, the storage device comprises a round and/or oval shaped bucket 110. As further shown within FIG. 1C, in some embodiments, the lid 111 is removable and/or separatable to access the interior 113 of the bucket 110.

As described above, bucket 110 is able to be filled with a plurality of objects, such as flowers, shapes, sports themed objects, and other objects. The plurality of objects are configured to be placed within the bucket 110 and separately taken from the bucket 110. Particularly, in some embodiments, the bucket 110 comprises one or more shapes or textures which correspond to the plurality of objects and enable a user to sort and/or arrange the objects according to the shapes and textures within the bucket 110.

As further shown within FIGS. 1D-1F, the storage device 100' is able to comprise an angular shape at the corner of the bucket 110'. In some embodiments, the storage device 100' is configured to hold a plurality of objects, such as described above.

In some embodiments, the storage device 100' comprises a silicone material. However, the storage device 100 is able to be constructed from any appropriately desired material. As shown within FIG. 1E, in some embodiments, the storage device 100' comprises a lid 101' which is opened to access an interior 103' of the storage device 100'. In some embodiments, the storage device 100' comprises a plurality of pieces. In some embodiments, the storage device 100' comprises a handle.

The storage device 100' is able to be filled with a plurality of objects, such as flowers, shapes, sports themed objects, and other objects. The plurality of objects are configured to be placed within the storage device 100' and separately taken from the storage device 100'. Particularly, in some embodiments, the storage device 100' comprises one or more shapes or textures which correspond to the plurality of objects and enable a user to sort and/or arrange the objects according to the shapes and textures within the storage device 100'.

As shown within FIG. 1F, the storage device such as described above comprises a silicone bucket 110'. In some embodiments, such as shown within FIG. 1F, the storage device comprises comprise an angular shape at the corner of the bucket 110'. As further shown within FIG. 1F, in some embodiments, the lid 111' is removable and/or separatable to access the interior 113' of the bucket 110'.

As described above, bucket 110' is able to be filled with a plurality of objects, such as flowers, shapes, sports themed objects, and other objects. The plurality of objects are configured to be placed within the bucket 110' and separately taken from the bucket 110'. Particularly, in some embodiments, the bucket 110' comprises one or more shapes or textures which correspond to the plurality of objects and enable a user to sort and/or arrange the objects according to the shapes and textures within the bucket 110'. In some embodiments, the plurality of objects comprise one or more of silicone, plastic and rubber.

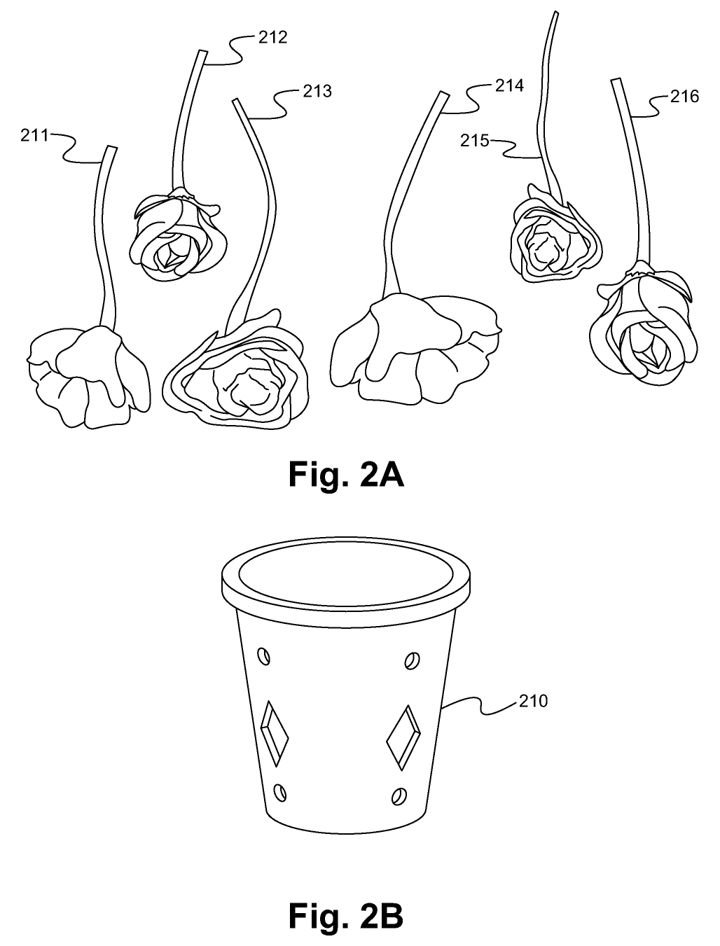

As shown within FIGS. 2A and 2B, in some embodiments the plurality of objects comprise a plurality of flowers 211, 212, 213, 214, 215, and 216 and a flower pot 210. In some embodiments, the flower pot 210 is configured to hold five or six flowers. However, the vase 210 is configured to hold any appropriately desired number of flowers. In some embodiments, the flowers 211, 212, 213, 214, 215, and 216 comprise silicone, bendable plastic and/or rubber. In some embodiments, the plurality of flowers 211, 212, 213, 214, 215, and 216 and the flower pot 210 comprise one or more arranging cues which instruct a user to arrange the plurality of flowers 211, 212, 213, 214, 215, and 216 and the vase 210 according to a pattern. For example, in some embodiments, the flowers 211, 212, 213, 214, 215, and 216 are arrangeable according to size or some other quality. In some embodiments, the flowers 211, 212, 213, 214, 215, and 216 comprise different colors and/or different patterns. The plurality of flowers 211, 212, 213, 214, 215, and 216 and the flower pot 210 are configured to fit within the storage device 100, such as described above.

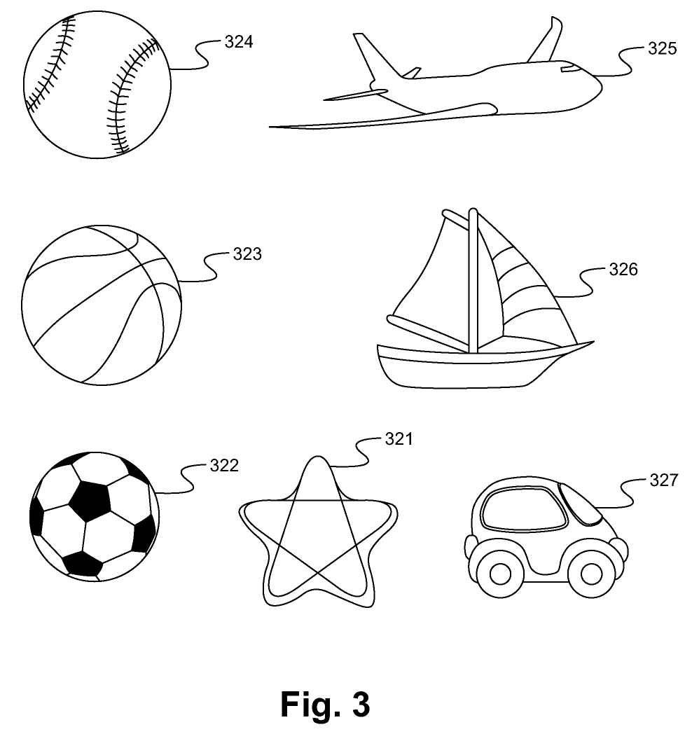

In further embodiments, such as shown within FIG. 3, the plurality of objects comprise a plurality of balls such as a soccer ball 322, a basketball 323, a baseball 324, and airplane 325, a boat 326, and a car 327. However, the plurality of objects can comprise other balls as well. For example, in some embodiments, the plurality of objects also comprise a star shaped ball 321. In some embodiments, the plurality of balls comprises one or more arranging cues which instruct a user to arrange the objects according to a determined pattern. The plurality of balls such as the soccer ball 322, the basketball 323, the baseball 324, and the airplane 325, the boat 326, and the car 327 are configured to fit within the storage device 100, such as described above. In some embodiments, the plurality of balls comprise silicone, bendable plastic and/or rubber.

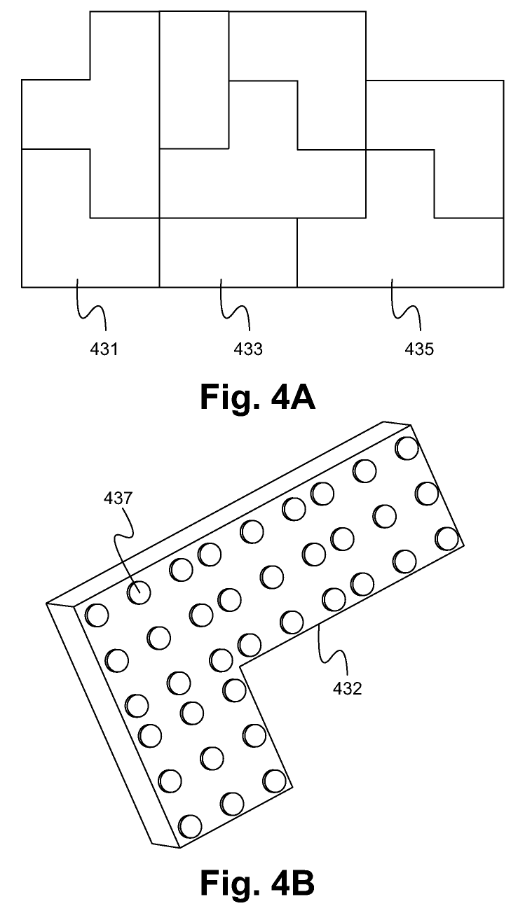

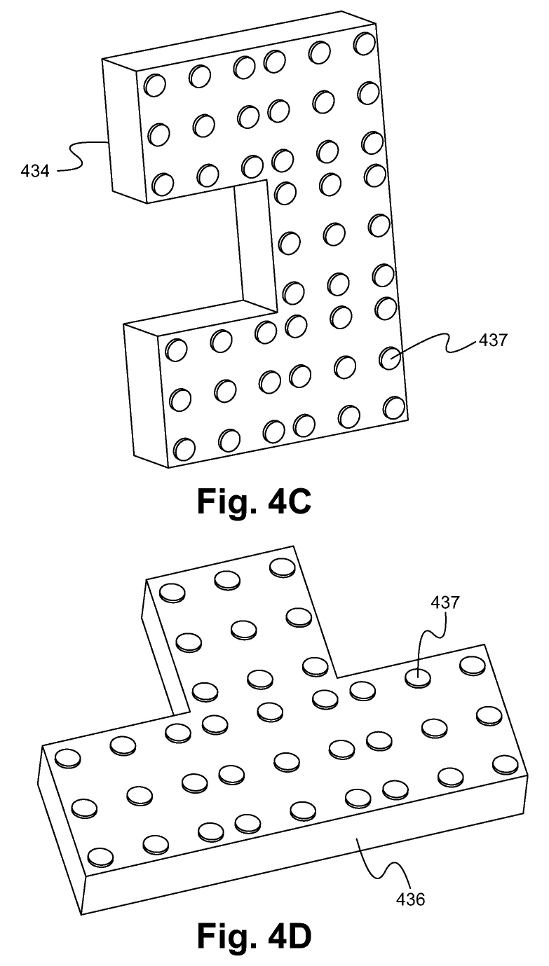

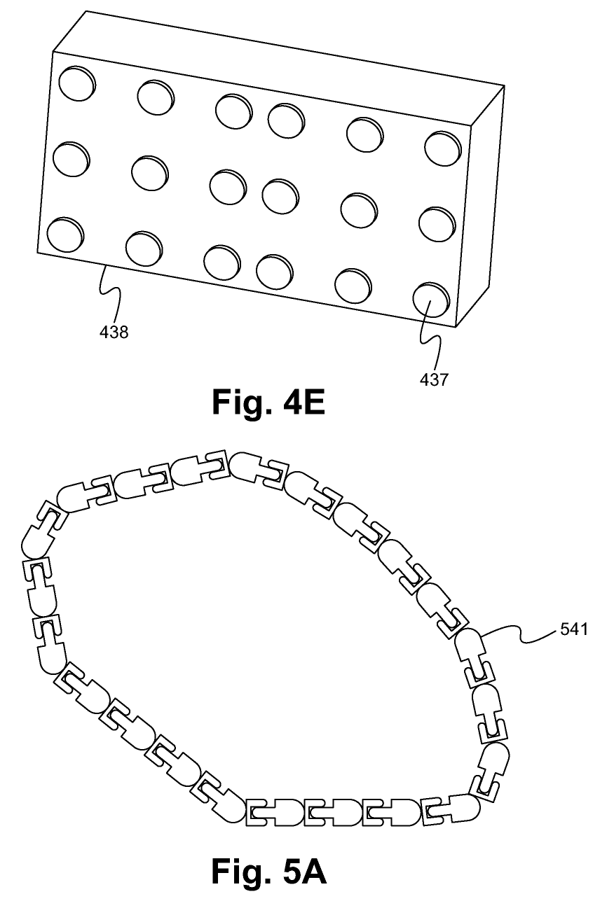

In some embodiments, the storage device 100 is configured to hold one or more interlocking pieces such as shown within FIG. 4A. As shown within FIG. 4A, in some embodiments, the one or more interlocking pieces 431, 433, and 435 comprise a plurality of different shapes. In some embodiments, the plurality of interlocking pieces comprise four shapes. In some embodiments, the plurality of interlocking pieces comprise four repeated shapes. Alternatively, in some embodiments the plurality of interlocking pieces comprise different shapes. In some embodiments, eight interlocking pieces are configured to fit within the storage device 100. However, any appropriately desired number of interlocking pieces are able to be fit within the storage device 100. In some embodiments, the plurality of interlocking pieces are configured to interlock and fit within a bottom of the storage device 100.

In some embodiments, such as shown in FIG. 4B-4E, a plurality of interlocking pieces 432, 434, 436 and 438 comprise tetris-like interlocking features. In some embodiments, the plurality of interlocking pieces 432, 434, 436 and 438 comprise one or more tactile features 437. For example, such as shown within FIG. 4B,the plurality of interlocking pieces 432, 434, 436 and 438 comprise a plurality of raised studs. However, the plurality of interlocking pieces 432, 434, 436 and 438 are able to comprise any appropriately desired tactile features. As described above, in some embodiments, the plurality of interlocking pieces comprise four repeated shapes. Alternatively, in some embodiments the plurality of interlocking pieces comprise different shapes. In some embodiments, eight interlocking pieces are configured to fit within the storage device 100. However, any appropriately desired number of interlocking pieces are able to be fit within the storage device 100. In some embodiments, the plurality of interlocking pieces are configured to interlock and fit within a bottom of the storage device 100. In some embodiments, the one or more interlocking pieces comprise silicone, bendable plastic and/or rubber.

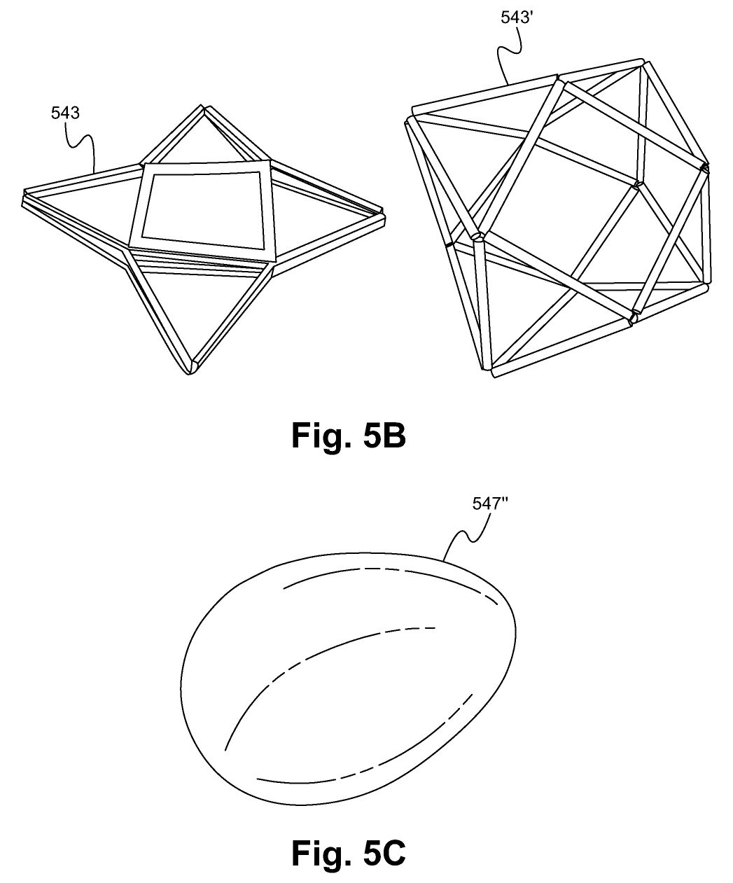

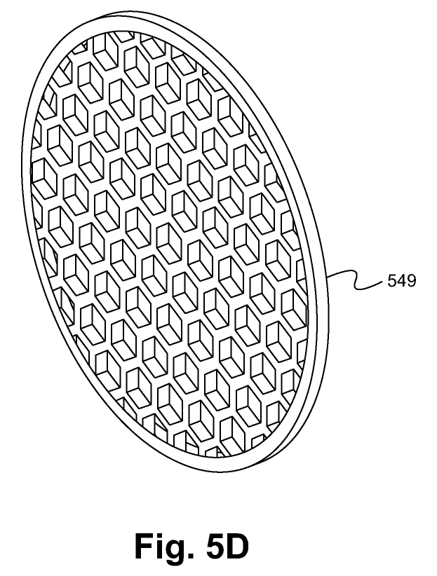

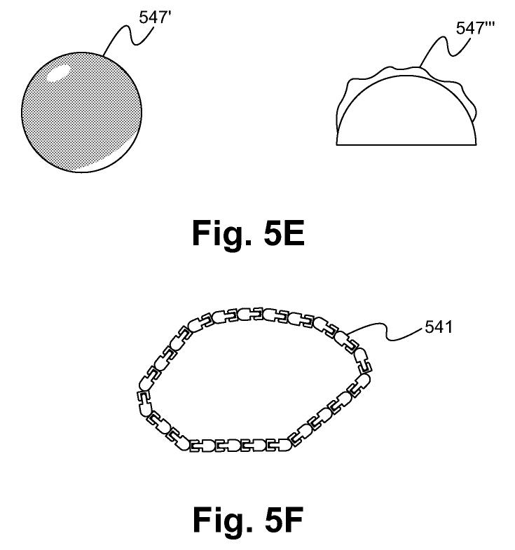

In further embodiments, a plurality of objects such as a round ball, a jointed chain-like object, a segmented puzzle, and an expanded puzzle are configured to be held by the storage device 100. For example, a segmented puzzle 541 is shown within FIG. 5A. The segmented puzzle 541 is able to folded and turned as it is held in the user’s hands and is also able to be folded to form a variety of different shapes. In some embodiments, the segmented puzzle 541 comprises a jointed chain-like object that makes a clicking noise as it is bent. In some embodiments, this jointed chain-like object is configured to be used as a crown and/or a bracelet and is able to be manipulated. In some embodiments, the segmented puzzle 541 comprises hard plastic.

FIG. 5B shows an object comprising one or more elastic tubes 543. In some embodiments, the one or more elastic tubes are used for tugging and manipulating a shape of the object. In some embodiments, the object comprises an expanding puzzle which is able to expand 543' and retract 543 as the object is tugged and manipulated.

FIGS. 5C-5F illustrate a round ball 547', an egg shape 547", and a taco shape 547'”. In some embodiments, the ball 547 is bendable and can be collapsed and stretched while being held. In some embodiments, the ball 547 comprises foam and/or rubber. The bendable frisbee shaped object 549, the segmented puzzle 541, the object 543, and the round ball 547 are configured to fit within the storage device 100, such as described above. In some embodiments, the frisbee shaped object 549 comprises a silicone textured bendable frisbee.

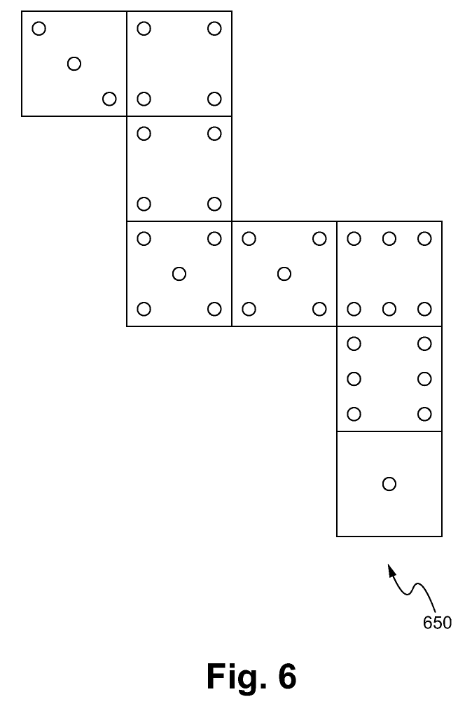

FIG. 6 illustrates a plurality of objects configured to fit within a storage device 100, such as described above. As shown within FIG. 6, the plurality of objects comprise a set of dominoes 650. In some embodiments, the dominoes comprise large silicone dominoes. In some embodiments, the dominoes are able to be stacked, bended and sorted as desired by a user. In some embodiments, the dominoes comprise silicone, bendable plastic and/or rubber.

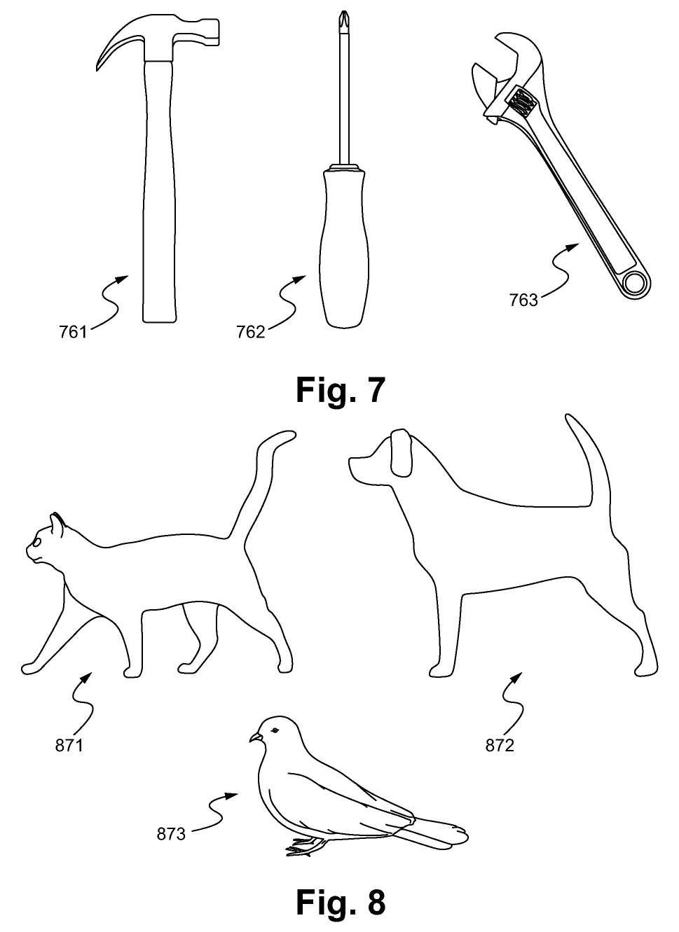

In further embodiments, a plurality of objects configured to fit within a storage device 100 comprise one or more silicone and/or plastic tools. For example, such as shown within FIG. 7, the plurality of objects comprise a hammer 761, a screwdriver 762 and a wrench 763. However, plurality of objects are able to comprise any number and types of tools as appropriately desired and capable of fitting within the storage device. In some embodiments, the tools comprise silicone, plastic and/or rubber.

In still further embodiments, the plurality of objects configured to fit within a storage device 100 are able to comprise one or more animals. For example, such as shown within FIG. 8, the plurality of objects comprise a cat 871, a dog 872 and a bird 873. However, plurality of objects are able to comprise any number and types of animals as appropriately desired and capable of fitting within the storage device. In some embodiments, the cat 871, the dog 872 and the bird 873 comprise silicone, bendable plastic and/or rubber.

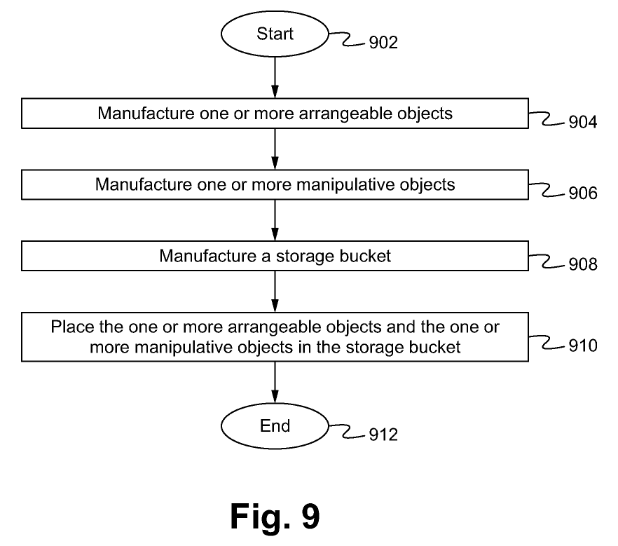

FIG. 9 illustrates a method of manufacturing a system for the stimulation of cognitive abilities. The method begins in the step 902. In the step 904, one or more arrangeable objects are manufactured. In some embodiments, the one or more arrangeable objects are arrangeable according to one or more of size, shape and texture. In the step 906, one or more manipulative objects are manufactured and in the step 908 a storage bucket is manufactured. In the step 910, the one or more arrangeable objects and the one or more manipulative objects are placed in the storage bucket. In some embodiments, the storage bucket removably holds the one or more arrangeable objects and the one or more manipulative objects when they are not being used. In some embodiments, the one or more arrangeable objects comprise one or more of a different sized object, a different shaped object, and a different textured object. In some embodiments, the one or more manipulative objects comprise one or more of an elastic tube, a segmented puzzle, a bendable ball, a bendable frisbee shaped object and a jointed chain-like object. In further embodiments, the one or more manipulative objects comprise a plurality of stackable items. The method ends in the step 912.

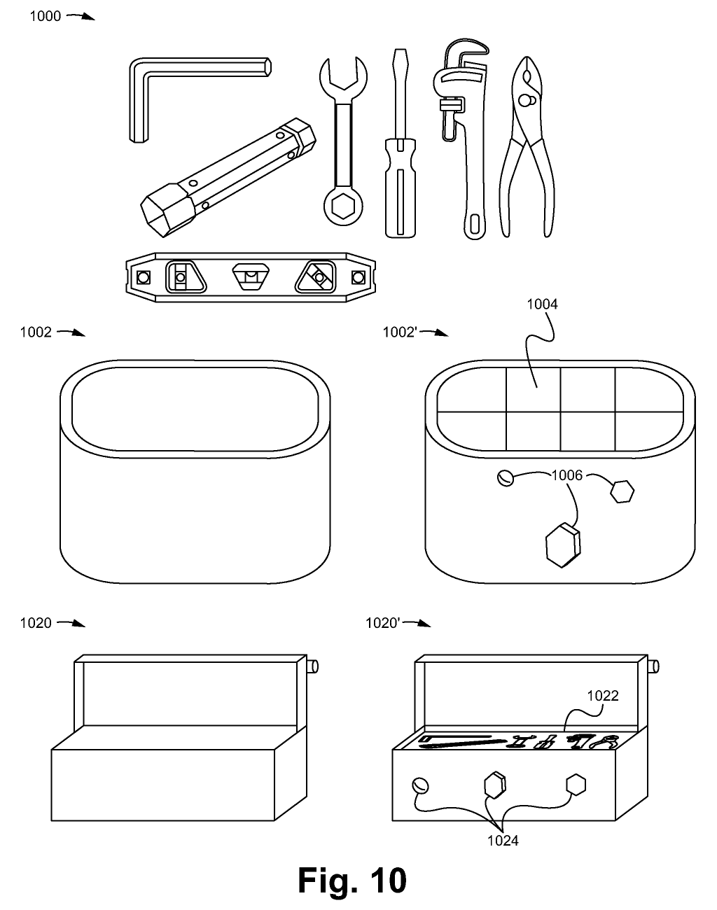

FIG. 10 illustrates a plurality of tools configured to fit within a storage device in accordance with some embodiments. The tools 1000 are able to include any tools such as an allen wrench, a hex pipe wrench, pliers, a wrench, a screwdriver, a pipe wrench, and a level. Any other tools are able to be included such as a saw, hammer, ruler, chisel, drill, flashlight, and goggles. The tools 1000 are able to be made of any material such as soft or hard silicone, soft or hard plastic, soft or hard rubber, metal, wood, foam or a combination thereof. In some embodiments, the tools 1000 are generally non-functional representations of real tools. In some embodiments, the tools 1000 are semi-functional such as pliers that are able to open and close. In some embodiments, the level includes liquid with a bubble inside one or more vials, and in some embodiments, the bubble, liquid and vials are representations of functional bubbles such as clear plastic for the vials with solid, colored plastic to represent the liquid and a bubble within the colored plastic.

The tools 1000 are able to be stored in a container 1002. In some embodiments, the container 1002 is an open container with a space large enough for receiving each of the tools 1000. In some embodiments, the container 1002’ includes a plurality of slots or sections, where each section is configured for receiving one of the tools 1000. In some embodiments, the container 1002’ includes interactive components 1006 that are able to be manipulated using the tools 1000. For example, the interactive components 1006 include a flathead screw, a hex bolt and a hex aperture. Furthering the example, the flathead screw is able to be manipulated with the screwdriver, and the hex bolt is able to be turned using the wrenches. The allen wrench is able to be inserted into the hex aperture. The interactive components 1006 are able to be on or in the container 1002’. There is able to be one interactive component 1006 for each tool 1000 or multiple interactive components for each tool 1000. In some embodiments, the interactive components 1006 are not the actual items and are meant to mimic the movement of the item without being able to be removed from the container 1002’. For example, to avoid the screw or bolt becoming a choking hazard, the screw is able to be turned, but regardless of how often it is turned, it will not come out of the container 1002’. The interactive components 1006 are able to embedded within the container 1006’ such that they are rotatable but not removable. In some embodiments, instead of the components being interactive, the items are for aesthetic purposes or for tactile stimulation.

In some embodiments, the container for storing the tools is shaped as a tool box 1020. In some embodiments, the tool box 1020 includes an open space for receiving the tools 1000. In some embodiments, the tool box 1020 includes slots/sections similar to those shown in the container 1002’. In some embodiments, the tool box 1020’ includes receiving depressions 1022 shaped similar to each tool. For example, an allen wrench depression is configured to receive the allen wrench tool, and a screwdriver depression is configured to receive the screwdriver. In some embodiments, the tool box 1020’ includes interactive components 1024 or non-interactive components as described for the container 1002’. The tool box 1020 is able to include any other features such as a handle for lifting the tool box 1020 or a lock for keeping the tool box 1020 closed.

Any of the items, components or features described for one embodiment is able to be implemented in/on another embodiment. The container 1002 and the tool box 1020 are able to be made of any material such as soft or hard silicone, soft or hard plastic, soft or hard rubber, metal, wood, foam or a combination thereof. The container 1002 and the tool box 1020 are able to be any shape, size or configuration.

In some embodiments, the tools 1000 and the container 1002 comprise one or more arranging cues which instruct a user to arrange tools 1000 according to a pattern. For example, in some embodiments, the tools 1000 are arrangeable according to size or some other quality. In some embodiments, the tools 1000 comprise different colors and/or different patterns. The tools 1000 and the container 1002 are configured to fit within a storage device 100, such as described above.

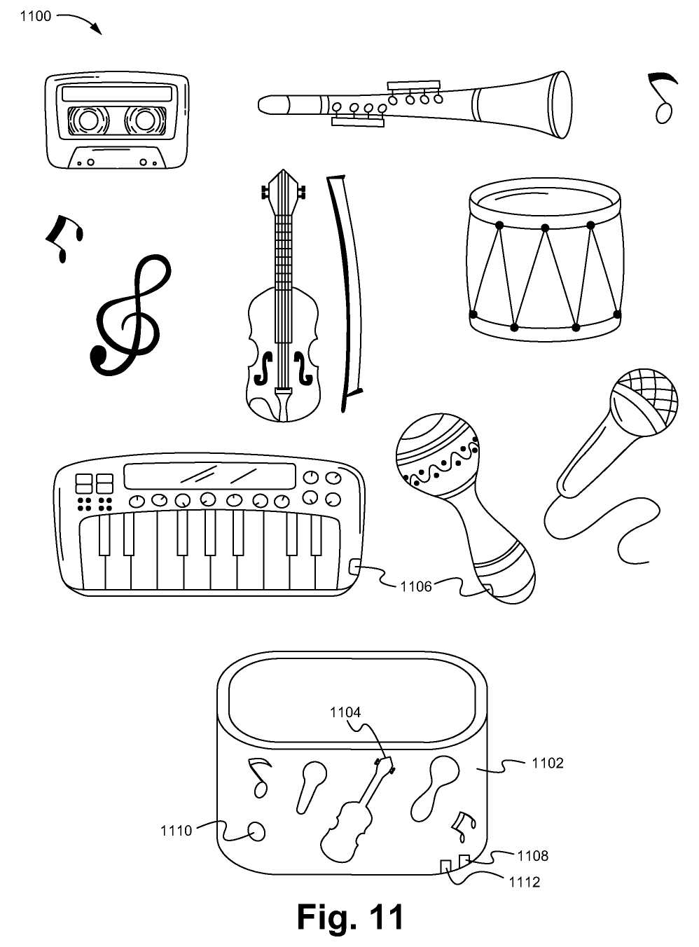

FIG. 11 illustrates music-related items configured to fit within a storage device in accordance with some embodiments. The music-related items 1100 are able to include any items related to music such as music notes, instruments, recording devices/mediums and playing devices/mediums. For example, various types of music notes (e.g., treble clef) are able to be included. The instruments are able to include any instrument such as a violin, flute, drum, trumpet, harp, maracas and others. The recording devices/mediums are able to include records, compact discs, cassettes and others. The playing devices/mediums are able to include mobile phones, mp3 players, walkmen, compact disc players, record players and others. The music-related items 1100 are able to be roughly the same size or varying sizes. The music-related items 1100 are able to be made of any material such as soft or hard silicone, soft or hard plastic, soft or hard rubber, metal, wood, foam or a combination thereof.

The music-related items 1100 are able to be stored in a container 1102. In some embodiments, the container 1102 is an open container with a space large enough for receiving each of the music-related items 1100. In some embodiments, the container 1102 includes a plurality of slots or sections, where each section is configured for receiving one of the music-related items 1100. In some embodiments, the container 1102 includes one or more apertures 1104. The one or more apertures 1104 are able to be shaped the same as or similar to the music-related items 1100.

In some embodiments, each of the music-based items 1100 includes an identifier 1106 which is able to be identified by an identification unit 1108 in the container 1102. The identifier 1106 is able to be a Radio Frequency IDentification (RFID) chip/tag, a sensor (e.g., photovoltaic) or any other identification mechanism. The identification unit 1108 is able to be an RFID reader, a sensor or any other implementation configured to detect and identify the identifier 1106. When a music-related item 1100 is detected, a corresponding sound is played through a speaker 1110 (with any accompanying circuitry/processing components) on/in the container 1102. The sounds are able to be stored in a memory 1112 in the container 1102. For example, a keyboard includes an identifier 1106 which is detected and used to identify the keyboard via the identification unit 1108 when the keyboard is placed in the container 1102. Then, a keyboard sound or tune, stored in the memory 1112, is played through the speaker 1110 upon identification of the keyboard. Each music-related item 1100 is able to have a corresponding sound or tune. In some embodiments, as each music-related item 1100 is placed in the container 1102, the tune or song includes that instrument in addition to previously added instruments. For example, if the container 1102 already has a keyboard and a clarinet, and a user places a violin in the container 1102, then the tune/song is replayed with the keyboard, clarinet and violin instead of just the keyboard and clarinet.

In some embodiments, each of the music-related items 1100 includes a speaker which is used to play a sound or tune based on the item being held by a user. For example, the identifier 1106 is a photovoltaic sensor which is covered when a user holds the item, and based on the sensor being covered, a tune stored in a memory in the item is played through the speaker.

Any of the items, components or features described for one embodiment is able to be implemented in/on another embodiment. The container 1102 is able to be made of any material such as soft or hard silicone, soft or hard plastic, soft or hard rubber, metal, wood, foam or a combination thereof. The container 1102 is able to be any shape, size or configuration.

In some embodiments, the music-related items 1100 and the container 1102 comprise one or more arranging cues which instruct a user to arrange the music-related items 1100 according to a pattern. For example, in some embodiments, the music-related items 1100 are arrangeable according to size or some other quality. In some embodiments, the music-related items 1100 comprise different colors and/or different patterns. The music-related items 1100 and the container 1102 are configured to fit within a storage device 100, such as described above.

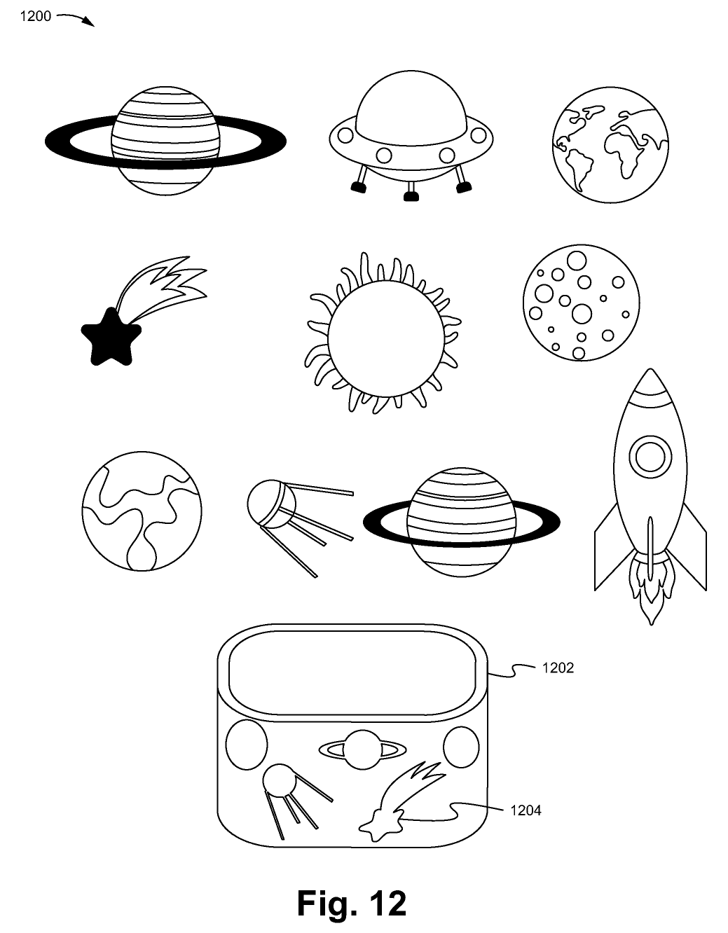

In some embodiments, the identifier 1106 and identification unit 1108 are used to track activity and usage. For example, the identification unit 1108 utilizes a counter to count how many items are removed from and/or input into the container 1102. In another example, the identification unit 1108 keeps track of how long one or more of the items are not within the container 1102 or how long the container 1102 is open. Any other activity/usage information is able to be tracked. For example, the amount of time from when the last item is removed from the container 1102 until the last item is placed back within the container 1102 is tracked. The tracked information is able to be communicated to another device (e.g., cloud device, phone) for further storage and analysis. For example, the amount of time for a user to place the items back in the container 1102 is tracked and charted. The activity/usage information is able to be used by a medical professional to help determine if a person’s medical condition is improving, staying the same or worsening. In some embodiments, additional embedded microchips, circuitry and/or other mechanisms are utilized to track activity and usage. FIG. 12 illustrates space-related items configured to fit within a storage device in accordance with some embodiments. The space-related items 1200 are able to include any items related to space such as planets (e.g., Mercury, Venus, Earth, Mars, Saturn, Jupiter, Uranus, Neptune), dwarf planets (e.g., Pluto), moons, stars (e.g., the sun), comets, meteorites, rockets, alien, rover and/or other space items. For example, the space-related items 1200 include the eight planets with relative sizes including distinguishing colors and/or textures. The space-related items 1200 are able to be made of any material such as soft or hard silicone, soft or hard plastic, soft or hard rubber, metal, wood, foam or a combination thereof.

The space-related items 1200 are able to be stored in a container 1202. In some embodiments, the container 1202 is an open container with a space large enough for receiving each of the space-related items 1200. In some embodiments, the container 1202 includes a plurality of slots or sections, where each section is configured for receiving one of the space-related items 1200. In some embodiments, the container 1202 includes one or more apertures 1204. The one or more apertures 1204 are able to be shaped the same as or similar to the space-related items 1200.

In some embodiments, each of the space-related items 1200 includes an identifier, and the container 1202 includes an identification unit and a speaker similar to the music-related items 1100 and container 1102. Space sounds such as a rocket ship blasting off or the names of the objects are able to be played when each item is detected. For brevity, the details that parallel the music-related items are not repeated, but the space-related items 1200 and container 1202 are able to function similarly to the music-related items 1100 and container 1102.

Any of the items, components or features described for one embodiment is able to be implemented in/on another embodiment. The container 1202 is able to be made of any material such as soft or hard silicone, soft or hard plastic, soft or hard rubber, metal, wood, foam or a combination thereof. The container 1202 is able to be any shape, size or configuration.

In some embodiments, the space-related items 1200 and the container 1202 comprise one or more arranging cues which instruct a user to arrange the space-related items 1200 according to a pattern. For example, in some embodiments, the space-related items 1200 are arrangeable according to size (e.g., smallest planet to largest planet or vice versa) or some other quality (e.g., closest to the sun to furthest from the sun or vice versa). In some embodiments, the space-related items 1200 comprise different colors and/or different patterns. The space-related items 1200 and the container 1202 are configured to fit within a storage device 100, such as described above.

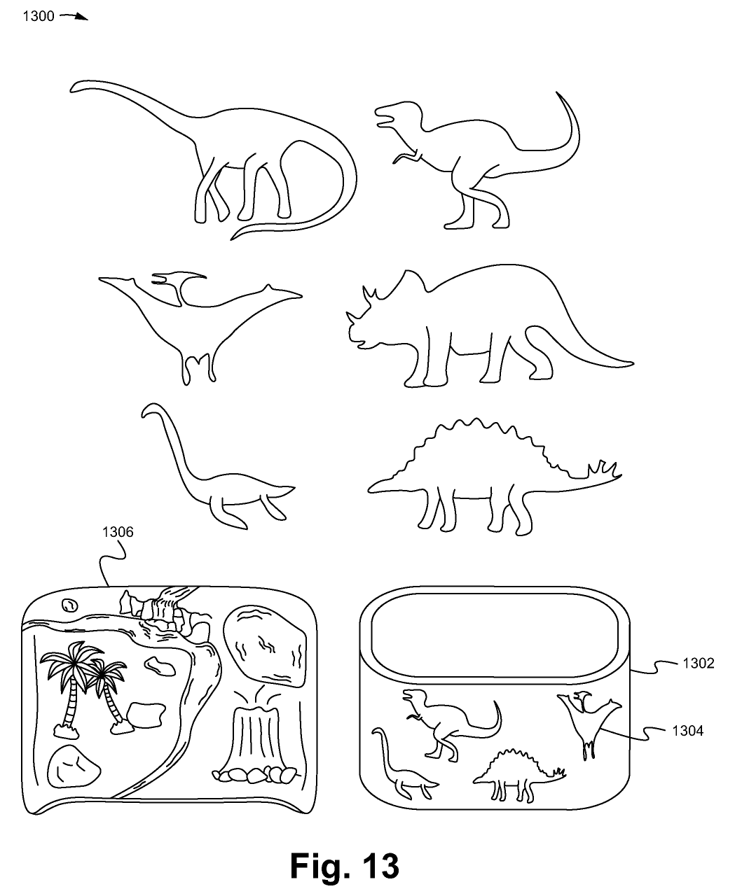

FIG. 13 illustrates dinosaur items configured to fit within a storage device in accordance with some embodiments. The dinosaurs 1300 are able to include any dinosaurs such as a Tyrannosaurus, Triceratops, Velociraptor, Stegosaurus, Spinosaurus, Pteranodon, and Brachiosaurus. For example, the dinosaurs 1300 include the dinosaurs with relative sizes including distinguishing colors and/or textures. The dinosaurs 1300 are able to be made of any material such as soft or hard silicone, soft or hard plastic, soft or hard rubber, metal, wood, foam, cotton, fur or a combination thereof.

The dinosaurs 1300 are able to be stored in a container 1302. In some embodiments, the container 1302 is an open container with a space large enough for receiving each of the dinosaurs 1300. In some embodiments, the container 1302 includes a plurality of slots or sections, where each section is configured for receiving one of the dinosaurs 1300. In some embodiments, the container 1302 includes one or more apertures 1304. The one or more apertures 1304 are able to be shaped the same as or similar to the dinosaurs 1300. In some embodiments, a mat 1306 is included. The mat 1306 is able to be made of any material such as silicone. The mat 1306 is able to be rolled up or folded and placed in the container 1302. The mat 1306 is able to have images, textures and/or other designs. For example, the mat 1306 includes an image of a landscape such that a user is able to enjoy the objects by interacting with the mat 1306.

In some embodiments, each of the dinosaurs 1300 includes an identifier, and the container 1302 includes an identification unit and a speaker similar to the music-related items 1100 and container 1102. Dinosaur sounds such as the sounds each dinosaur makes or the names of the dinosaurs are able to be played when each item is detected. For brevity, the details that parallel the music-related items are not repeated, but the dinosaurs 1300 and container 1302 are able to function similarly to the music-related items 1100 and container 1102.

Any of the items, components or features described for one embodiment is able to be implemented in/on another embodiment. The container 1302 is able to be made of any material such as soft or hard silicone, soft or hard plastic, soft or hard rubber, metal, wood, foam or a combination thereof. The container 1302 is able to be any shape, size or configuration.

In some embodiments, the dinosaurs 1300 and the container 1302 comprise one or more arranging cues which instruct a user to arrange the dinosaurs 1300 according to a pattern. For example, in some embodiments, the dinosaurs 1300 are arrangeable according to size (e.g., smallest dinosaur to largest dinosaur or vice versa). In some embodiments, the dinosaurs 1300 comprise different colors, different patterns and/or different textures. For example, a dinosaur believed to have smooth skin is represented by a smooth surface dinosaur piece, and a dinosaur believe to have spikes is represented by a spikey surface dinosaur piece. The dinosaurs 1300 and the container 1302 are configured to fit within a storage device 100, such as described above.

Similar to dinosaurs, items of other animals and objects are able to manufactured for manipulation including a user placing them in a container. The animals and objects are able to include representative colors, textures, sizes and/or other features. For example, for jungle animals, a tiger item is colored with orange and black stripes. In another example, a crocodile item is made with a smooth yet bumpy texture. In another example, an elephant item is larger than a lion item. These examples represent the different colors, textures and sizes that are able to be utilized. Other features are able to be used to distinguish items. The animals and objects are able to include corresponding sounds. For example, a tiger item is able to include a “roar” sound or the word “tiger” is able to be played when the tiger item is placed in a container. Other items are able to include: multiple types of trains (e.g., steam engine, diesel, electric); train cars (e.g., engine, caboose, dining car, coal car, sleeper car); various kinds of transportation (e.g., plane, boat, car, train, bicycle, jet, scooter); objects associated with sports (e.g., basketball, baseball, football, hockey puck, soccer ball, tennis ball, golf ball, ping pong ball, pickleball, paddle, bat); pets (e.g., dog, cat, bird, turtle, snake, rabbit); seashore (e.g., different types of seashells, starfish, sea glass, sea life, fish, wave, boat); Earth/weather (e.g., sun, moon, clouds, heart, rainbow); cooking/kitchen objects (e.g., spatula, fork, knife, spoon, pan, whisk, tongs, bowl, measuring spoon cluster, frying pan, pot, oven mitt); foods (e.g., taco, meatball, spaghetti, sushi, cake, pie slice, cookie, fries, hotdog, burger, pizza, mac & cheese bowl, fried chicken); specific foods (e.g., pastas – spaghetti, fettuccine, fusilli, penne, macaroni, lasagna, ravioli); desserts (e.g., cake, pie, cookies, brownies, candy, donut, cupcake, popsicle, ice cream cone); art (e.g., pencil, sharpener, eraser, easel, paint brush, painting knife, paint tube, palette); breakfast (e.g., mug, skillet, fried egg, toast, jam jar); shapes (e.g., circle, square, triangle, rectangle, oval, hexagon); farm animals (e.g., cow, pig, sheep, chicken, horse, duck, barn); zoo animals (e.g., giraffe, monkey, zebra, kangaroo, hippo, parrot); aquatic animals (e.g., dolphin, whale, turtle, crab, jellyfish, fish); garden objects (e.g., watering can, butterfly, bird, snail, leaf, mushroom, ladybug, flower); travel objects (e.g., suitcase, globe, camera, map, hat, compass); birds and bees (e.g., bee, beehive, birdhouse, bird, nest with egg, sunflower); cars (e.g., VW beetle, VW van, sports car, pickup truck, bus, taxi); fantasy (e.g., unicorn, dragon, castle, magic wand, crown, star); oven items (e.g., oven mitt, rolling pin, muffin, cookie, bread loaf, pie slice); and dominoes with various number of dots.

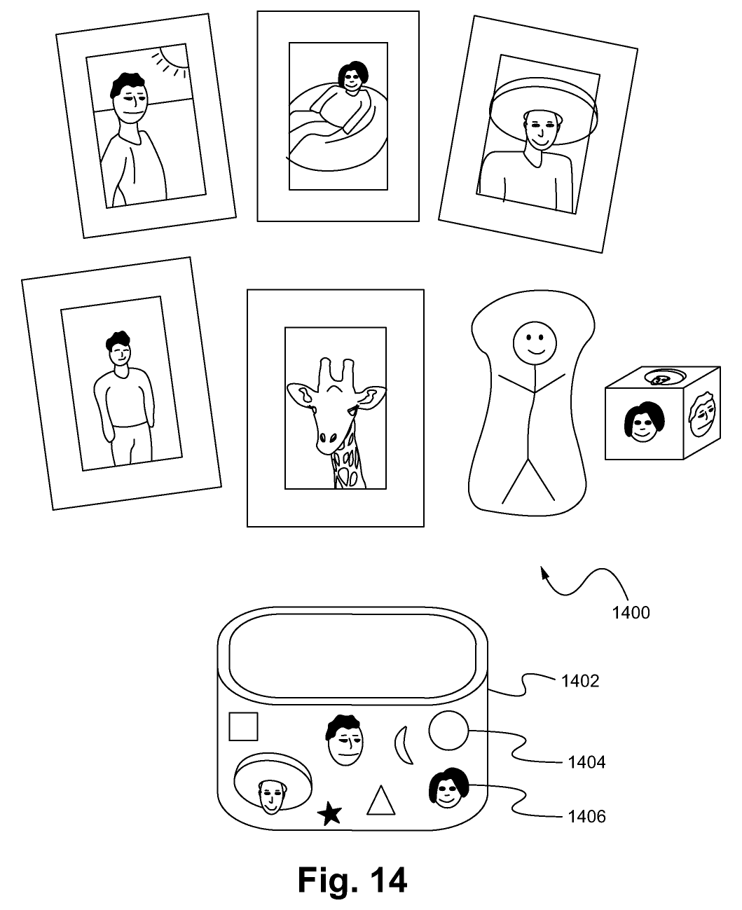

FIG. 14 illustrates photograph-based items configured to fit within a storage device in accordance with some embodiments. The photograph-based items 1400 are able to be generated by supplying a set of photographs which are then used to determine a shape of an item and the photograph or a portion of the photograph that is applied to the item. For example, an image is printed or drawn on a piece of material. Furthering the example, a person is able to submit a set of photographs of relatives (e.g., children, grandchildren) to be printed on silicone shapes which are then able to be admired, sorted and placed in a container 1402. The photograph-based items 1400 are able to be relatively flat 3D objects (e.g., squares, rectangles, circles, ovals), cube objects, spherical objects, or objects of another shape.

The photograph-based items 1400 are able to be stored in a container 1402. In some embodiments, the container 1402 is an open container with a space large enough for receiving each of the photograph-based items 1400. In some embodiments, the container 1402 includes a plurality of slots or sections, where each section is configured for receiving one of the photograph-based items 1400. In some embodiments, the container 1402 includes one or more apertures 1404. The one or more apertures 1404 are able to be shaped the same as or similar to the photograph-based items 1400 or other shapes. In some embodiments, the container 1402 includes one or more photographs 1406 that were provided. For example, the one or more photographs 1406 are printed on the side of the container 1402.

In some embodiments, each of the photograph-based items 1400 includes an identifier, and the container 1402 includes an identification unit and a speaker similar to the music-related items 1100 and container 1102. Voices or names (e.g., of the relatives) are able to be played when each item is detected. For example, in addition to submitting photographs, a person is able to submit sound clips/messages (e.g., from relatives) in any format which are able to be stored in a memory in the container 1402. For brevity, the details that parallel the music-related items are not repeated, but the photograph-based items 1400 and container 1402 are able to function similarly to the music-related items 1100 and container 1102.

Any of the items, components or features described for one embodiment is able to be implemented in/on another embodiment. The container 1402 is able to be made of any material such as soft or hard silicone, soft or hard plastic, soft or hard rubber, metal, wood, foam or a combination thereof. The container 1402 is able to be any shape, size or configuration.

In some embodiments, the photograph-based items 1400 and the container 1402 comprise one or more arranging cues which instruct a user to arrange the photograph-based items 1400 according to a pattern. For example, in some embodiments, the photograph-based items 1400 are arrangeable according to relationship (e.g., ascending or descending a family tree). In some embodiments, the photograph-based items 1400 comprise different colors and/or different patterns. The photograph-based items 1400 and the container 1402 are configured to fit within a storage device 100, such as described above.

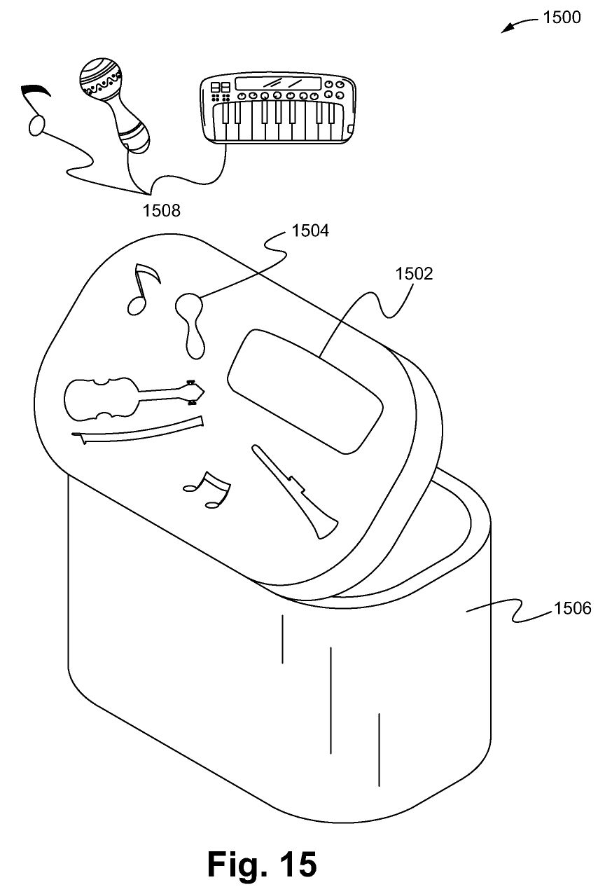

FIG. 15 illustrates a sorting container in accordance with some embodiments. The sorting container 1500 includes a top 1502 and a base 1506. The top 1502 is configured to have a plurality of apertures 1504 which are configured to receive a plurality of items 1508. For example, each aperture is configured to receive one item. Furthering the example, the music note aperture is configured to receive the music note item, but the keyboard item will not fit in the music note aperture. The plurality of items 1508 are able to be any items such as the tools, music-related items, space-related items, and others. The top 1502 is able to be removed to retrieve the plurality of items 1508. The sorting container 1500 is able to include other features described herein such as the identification implementation and speaker to produce a sound related to the received item.

Any of the items, components or features described for one embodiment is able to be implemented in/on another embodiment. The sorting container 1500 and the plurality of items 1508 are able to be made of any material such as soft or hard silicone, soft or hard plastic, soft or hard rubber, metal, wood, foam or a combination thereof. The sorting container 1500 and the plurality of items 1508 are able to be any shape, size or configuration.

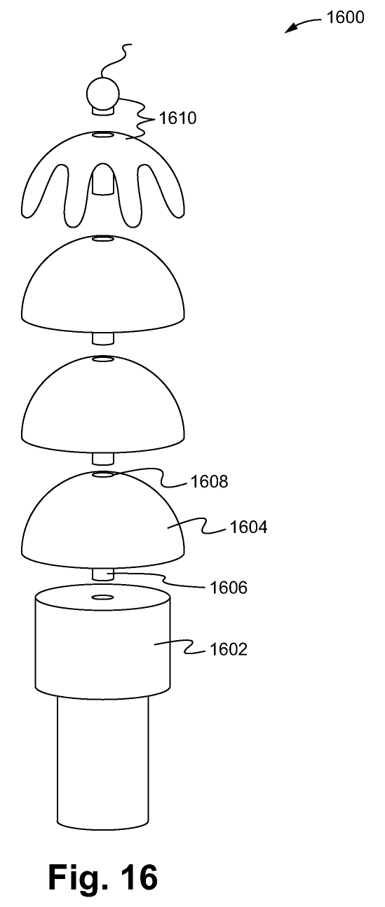

FIG. 16 illustrates an ice cream implementation according to some embodiments. The ice cream implementation 1600 includes one or more cones 1602 and one or more ice cream scoops 1604. The cone 1602 is able to be any type of cone such as a sugar cone, a waffle cone or another type of cone. In some embodiments, instead of or in addition to a cone, an ice cream cup/bowl is included. The one or more ice cream scoops 1604 are able to be any color or texture to represent any flavor of ice cream (e.g., pink to represent strawberry, white for vanilla, and brown for chocolate). The one or more ice cream scoops 1604 are able to be any shape such as approximately a sphere, semi-sphere, or rounded.

The cone 1602 and the one or more ice cream scoops 1604 are able to include a connecting implementation to enable the scoops to be connected such that they are stackable. For example, the top of the cone 1602 includes a slot 1608 configured for receiving a tab 1606 on the bottom of an ice cream scoop. Similarly, the top of each ice cream scoop includes a slot 1608 configured for receiving the tab 1606 on the bottom of another ice cream scoop. The tab 1606 and slot 1608 are able to be configured for a friction fit such that they are secure when inserted but also able to be pulled apart. In some embodiments, the connection implementation is another implementation such as Velcro or magnets. In some embodiments, the connection implementation is similar to a jig saw puzzle such that the ice cream scoops connect to each other that way.

In some embodiments, in addition to ice cream scoops, toppings 1610 are able to be added such as chocolate syrup, strawberry syrup, caramel, butterscotch, and/or a cherry. The toppings 1610 are able to be added in a similar manner.

A user is able to mix and match the ice cream scoops and toppings to produce the ice cream cone of their choice.

Any of the items, components or features described for one embodiment is able to be implemented in/on another embodiment. The one or more cones 1602 and the one or more ice cream scoops 1604 are able to be made of any material such as soft or hard silicone, soft or hard plastic, soft or hard rubber, metal, wood, foam or a combination thereof. The one or more cones 1602 and the one or more ice cream scoops 1604 are able to be any shape, size or configuration.

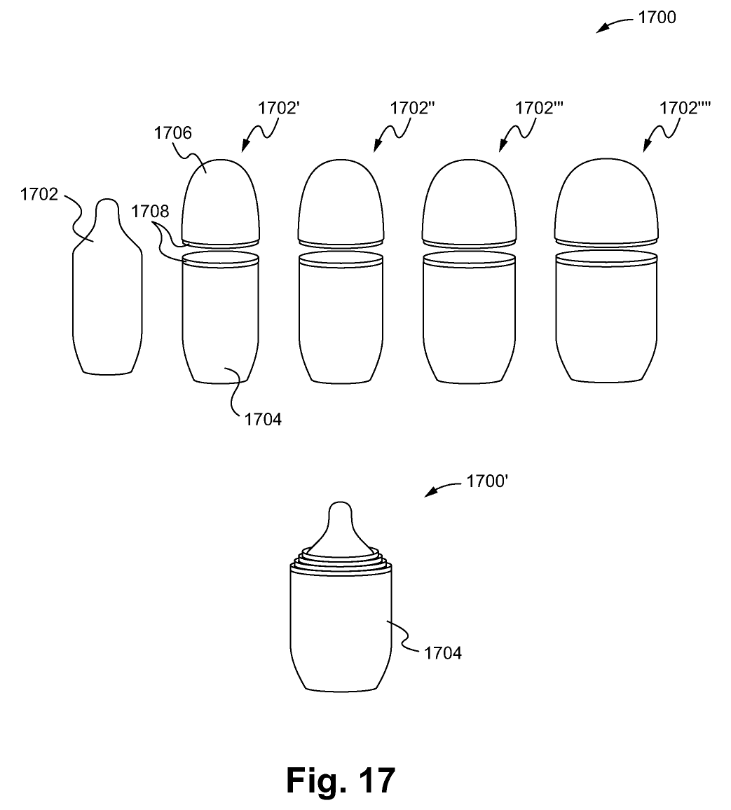

FIG. 17 illustrates nesting dolls according to some embodiments. Nesting dolls 1700 include multiple dolls which are sized such that one doll is able to fit within another doll and so on. A first nesting doll 1702 is sized to be able to fit within a second nesting doll 1702’ which is sized to be able to fit within a third nesting doll 1702” which is sized to be able to fit within a fourth nesting doll 1702”’ which is sized to be able to fit within a fifth nesting doll 1702””. More or fewer nesting dolls are able to be utilized. Each nesting doll includes two parts, a bottom part 1704 and a top part 1706. Threading 1708 or another implementation enables the bottom part 1704 and the top part 1706 to be joined together. In some embodiments, instead of threading 1708, the bottom part 1704 and the top part 1706 are configured to be pressed together for a friction fit. In some embodiments, the first nesting doll 1702 is not comprised of two parts.

A nested configuration 1700’ of the bottom parts 1704 and the top of the first nesting doll 1702 are shown.

Any of the items, components or features described for one embodiment is able to be implemented in/on another embodiment. The nesting dolls 1700 are able to be made of any material such as soft or hard silicone, soft or hard plastic, soft or hard rubber, metal, wood, foam or a combination thereof. The nesting dolls 1700 are able to be any shape, size or configuration.

Although the nesting dolls 1700 are referred to as dolls, they are able to be any figure/object such as sports equipment (e.g., a golf ball nested in a tennis ball nested in a baseball, and so on), animals (e.g., a mouse nested in a cat nested in a dog, and so on), other animals (e.g., penguins, bears, owls), personalized people figurines (e.g., relatives), and/or objects (e.g., planets).

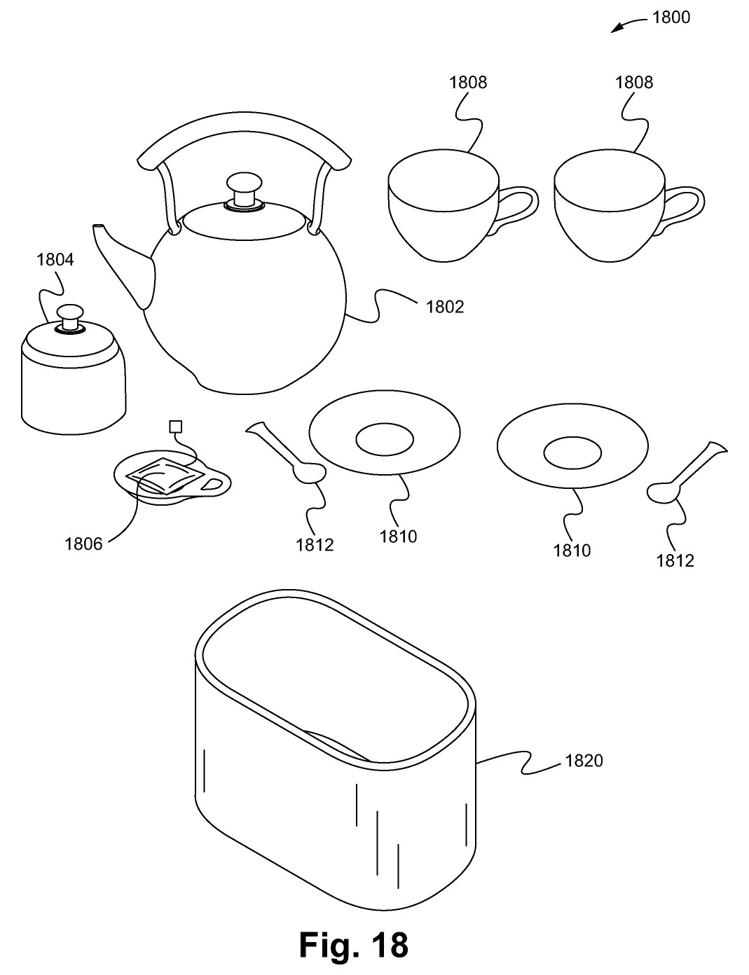

FIG. 18 illustrates tea set items according to some embodiments. The tea set 1800 includes a tea pot 1802, a sugar pot 1804, a tea bag 1806, one or more cups 1808, one or more saucers 1810, one or more spoons 1812, and/or other items. The tea set 1800 is able to be stored in a container 1820.

Any of the items, components or features described for one embodiment is able to be implemented in/on another embodiment. The tea set 1800 and the container 1820 are able to be made of any material such as soft or hard silicone, soft or hard plastic, soft or hard rubber, metal, wood, foam or a combination thereof. The tea set 1800 and the container 1820 are able to be any shape, size or configuration.

In some embodiments, the tea set 1800 and the container 1802 comprise one or more arranging cues which instruct a user to arrange the tea set 1800 according to a pattern. In some embodiments, the tea set 1800 comprises different colors and/or different patterns. The tea set 1800 and the container 1820 are configured to fit within a storage device 100, such as described above.

The sorting container 1820 is able to include other features described herein such as the identification implementation and speaker to produce a sound related to the received item. In some embodiments, each component includes an implementation (e.g., a magnet) to trigger a speaker to play a stored sound. For example, when the spout of the teapot 1802 is near a teacup 1808, then a pouring sound is played.

Any of the items, components or features described for one embodiment is able to be implemented in/on another embodiment. For example, elements of the music-related items and container are able to be used with the tools, and so on. Any of the items, components or features described are able to be substantially two dimensional or three dimensional. In some embodiments, for safety purposes, the items, components or features are not made of wood, metal or other hard materials. The containers and/or buckets described herein are able to be any shape or size. In some embodiments, the items, components or features are made of silicone such that they are dishwasher safe. The containers and/or buckets described herein are able to have cutouts, images, textures, and/or nothing on the walls/exterior. Any of the items, components or features are able to include a mat for interactive play. For example, various roadways/tracks are able to be on the mat for transportation items, or a jungle or other landscape is able to be included with animal items. In some embodiments, the items, components or features do not include speakers or other audio components. In some embodiments, any of the items, components or features described herein include one or more scents. For example, a food item is manufactured such that it smells as it looks (e.g., a chocolate chip cookie item smells like a chocolate chip cookie). The scent is able to be applied in any manner such as injecting or spraying on a scent.

The items, components or features are configured to be suitable for a target market which extends beyond dementia and cognitive challenges to include neurodivergent individuals, and individuals with autism, ADHD, rehab patients, stroke rehab, arthritis, and general sensory engagement for ages 3–100+.

More than 55 million people worldwide are living with dementia, a number expected to rise to 78 million by 2030 and 139 million by 2050. It is the seventh leading cause of death, with nearly 10 million new cases diagnosed annually-one every 3.2 seconds. Over 60% of affected individuals live in low- and middle-income countries.

### From Autism Speaks

Autism prevalence

1 in 31 children in the U.S. has autism, up from the previous rate of 1 in 36.

1 in 45 adults in the U.S. has autism.

In the U.S., about 4 in 100 boys and 1 in 100 girls have autism.

Boys are nearly 4 times more likely to be diagnosed with autism than girls.

In the U.S., autism prevalence is lower among white children than other racial and ethnic groups:

White – 2.7%

Hispanic – 3.3%

Black – 3.7%

Asian or Pacific Islander – 3.8%

American Indian or Alaska Native – 3.8%

Around the world, 1 in 100 children are diagnosed with autism.

The items, components or features described herein are able to be used by individuals with such conditions.

In operation, a storage device is able to be filled with a variety of different objects such as flowers, balls, shapes, and bendable objects. The plurality of objects are able to be placed within the storage device and taken out of the storage device. Additionally, the plurality of objects are able to be arranged according to one or more arranging cues. Particularly, the storage device and the plurality of objects offers exercise for the hands and arms as well as provides sensory and memory stimulation to the user as the objects are arranged. Accordingly, the manipulation system as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

1. An object manipulation system, the system comprising: a. a storage device with one or more interactive components positioned on the storage device; and b. a plurality of objects configured to be placed within the storage device and separately taken out of the storage device, wherein the plurality of objects are arrangeable according to one or more arranging cues, wherein the one or more interactive components are configured to be manipulated by an object of the plurality of objects.

2. The system of claim 1, wherein the plurality of objects comprise tools, musical instruments, space-related items, dinosaurs, personalized items, ice cream, nesting objects, a tea set, trains, transportation, jungle animals, sports equipment, pets, seashore objects, Earth, weather, cooking or kitchen objects, food items, dessert items, art items or dominoes.

3. The system of claim 1, wherein the one or more interactive components are non- removable from the storage device.

4. The system of claim 1, wherein the storage device comprises a tool box.

5. The system of claim 1, wherein the storage device comprises an identification detector configured to detect an identifier in each object of the plurality of objects.

6. The system of claim 5, wherein the identification detector comprises a Radio Frequency IDentification (RFID) reader, and the identifier comprises an RFID chip.

7. The system of claim 5, wherein the storage device further comprises a memory for storing one or more sounds, and a speaker for playing the one or more sounds based on the identification detector detecting the identifier.

8. The system of claim 1, wherein the storage device comprises a plurality of apertures.

9. The system of claim 1, wherein the plurality of objects comprise one or more of silicone,plastic and rubber.

10. The system of claim 1, wherein the one or more sorting cues comprise size, shape and texture.

11. The system of claim 1, wherein the storage device comprises a sorting box with a plurality of apertures, wherein each aperture of the plurality of apertures is configured to receive a single object of the plurality of objects.

12. A manipulation system for the stimulation of cognitive abilities, the system comprising: a. one or more arrangeable objects, the one or more arrangeable objects comprising one or more of a different sized object, a different shaped object, and a different textured object, wherein the one or more arrangeable objects are arrangeable according to one or more of size, shape and texture; b. a storage bucket for removably holding the one or more arrangeable objects when not being used, the storage bucket comprising one or more interactive components positioned on the storage bucket, wherein the one or more interactive components are configured to be manipulated by an object of the plurality of arrangeable objects.

13. The system of claim 12, wherein the plurality of interactive objects comprise tools,musical instruments, space-related items, dinosaurs, personalized items, ice cream,
nesting objects, a tea set, trains, transportation, jungle animals, sports equipment, pets,
seashore objects, Earth, weather, cooking or kitchen objects, food items, dessert items, art items or dominoes.

14. The system of claim 12, wherein the one or more interactive components are non- removable from the storage bucket.

15. The system of claim 12, wherein the storage bucket comprises a tool box.

16. The system of claim 12, wherein the storage bucket comprises an identification detector configured to detect an identifier in each object of the plurality of arrangeable objects.

17. The system of claim 16, wherein the identification detector comprises a Radio Frequency IDentification (RFID) reader, and the identifier comprises an RFID chip.

18. The system of claim 16, wherein the storage bucket further comprises a memory for storing one or more sounds, and a speaker for playing the one or more sounds based on the identification detector detecting the identifier.

19. The system of claim 12, wherein the storage bucket comprises a plurality of apertures.

20. The system of claim 12, wherein the plurality of arrangeable objects comprise one or more of silicone, plastic and rubber.

21. The system of claim 12, wherein the storage bucket comprises a sorting box with a plurality of apertures, wherein each aperture of the plurality of apertures is configured to receive a single object of the plurality of arrangeable objects.

22. A method of manufacturing a system for the stimulation of cognitive abilities, the method comprising: a. manufacturing one or more manipulative objects; b. manufacturing a storage bucket; and c. placing the one or more manipulative objects in the storage bucket, wherein the storage bucket removably holds the one or more manipulative objects when they are not being used, wherein the storage bucket comprises one or more interactive components, wherein the one or more interactive components are configured to be manipulated by an object of the plurality of manipulative objects.

23. The method of claim 22, wherein the plurality of manipulative objects comprise tools,musical instruments, space-related items, dinosaurs, personalized items, ice cream,nesting objects, a tea set, trains, transportation, jungle animals, sports equipment, pets,seashore objects, Earth, weather, cooking or kitchen objects, food items, dessert items, art items or dominoes.

24. The method of claim 22, wherein the one or more interactive components are non- removable from the storage bucket.

25. The method of claim 22, wherein the storage bucket comprises an identification detector configured to detect an identifier in each object of the plurality of manipulative objects.

26. The method of claim 25, wherein the identification detector comprises a Radio Frequency IDentification (RFID) reader, and the identifier comprises an RFID chip.

27. The method of claim 25, wherein the storage bucket further comprises a memory for storing one or more sounds, and a speaker for playing the one or more sounds based on the identification detector detecting the identifier.

28. The method of claim 22, wherein the plurality of manipulative objects comprise one or more of silicone, plastic and rubber.

29. The method of claim 22, wherein the storage bucket comprises a sorting box with a plurality of apertures, wherein each aperture of the plurality of apertures is configured to receive a single object of the plurality of manipulative objects.
